(19) United States
(12) Patent Application Publication
(10) Pub. No.: US 2023/0214785 A1
(43) Pub. Date: Jul. 6, 2023

(54) Methods And Systems For Managing Calendar Data

(71) Applicant: Dakota Paradise, LLC, Bryn Mawr, PA (US)

(72) Inventors: Priya Stanley, Bryn Mawr, PA (US); William Costin, Bryn Mawr, PA (US)

(21) Appl. No.: 18/068,174

(22) Filed: Dec. 19, 2022

Related U.S. Application Data
(60) Provisional application No. 63/316,757, filed on Mar. 4, 2022.
(60) Provisional application No. 63/295,641, filed on Dec. 31, 2021.

(51) Int. Cl. G06Q 10/1093; H04L 67/141

(52) U.S. Cl. CPC G06Q 10/1095; H04L 67/141

(57) ABSTRACT

Methods and systems for management of calendar data are described herein.

### CROSS-REFERENCE TO RELATED PATENT APPLICATIONS

This application claims the benefit of, and priority to, U.S. Provisional Pat. Application Number 63/295,641, filed on Dec. 31, 2021, and U.S. Provisional Pat. Application Number 63/316,757, filed on Mar. 4, 2022, both of which are incorporated by reference in their entireties herein.

### BACKGROUND

A large population of users rely upon online calendars and related software applications to manage their schedules. Relatedly, new applications for managing a calendar are become increasingly available. As these new applications gain popularity amongst users, issues associated with integration and compatibility between one calendar application and another calendar application arise. For example, it is becoming increasingly common for a user to be unable to schedule a meeting with a group of users through a single application. Rather, the user is forced to either send multiple calendar invitations that are duplicative of one another through different applications.

### SUMMARY

It is to be understood that both the following general description and the following detailed description are exemplary and explanatory only and are not restrictive. Methods and systems for managing calendar data are described.

In an aspect, a request associated with a new calendar data entry may be received. One or more fields associated with a type of the new calendar data entry may be retrieved from a first software platform based on a first software platform interface and a type of the new calendar data entry. A user interface of a user device may be generated based on the one or more fields. One or more values associated with the one or more fields may be received via the user interface. A communication address may be requested from a second software platform based on a second software platform interface. The one or more values associated with the one or more fields, as well as the communication address may be sent to the first software platform, based on the first software platform interface, in order to cause the first software platform to create the new calendar data entry based on the one or more values associated with the one or more fields and the communication address.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate example embodiments and together with the description, serve to explain the principles of the apparatuses, methods and systems described herein:

FIG. 1 is a flowchart of an example method for management of calendar data;

FIG. 2 is a diagram of an exemplary system and network;

FIG. 3 is a flowchart of an example method for management of calendar data;

FIGS. 4-7 are examples of a user interface relative to the management of calendar data;

FIG. 8 is a flowchart of an example method for management of calendar data;

FIG. 9 is a flowchart of an example method for management of calendar data;

FIG. 10 is a diagram of an exemplary system and network; and

FIG. 11 is a diagram of an exemplary cloud-based system and network.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes- from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Methods and systems are described herein for interfacing with a plurality of software platforms via a plurality of software platform interfaces to integrate audio and/or video conferencing capabilities of one software platform into calendar data entries of another software platform.

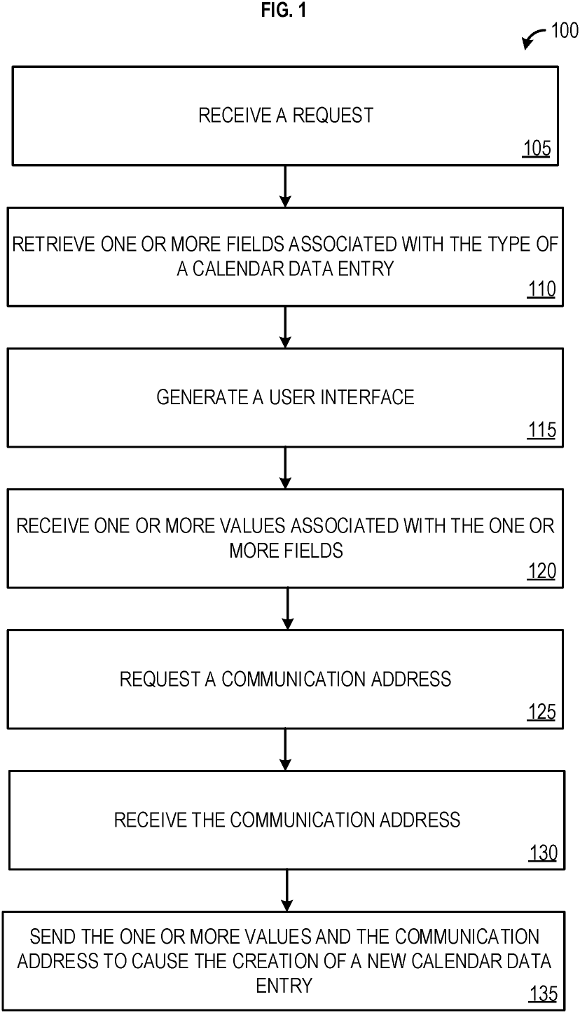

FIG. 1 is a flowchart illustrating an example method 100 for managing calendar data, such as a calendar data entry. A calendar data entry may be a calendar appointment, a meeting request, and/or the like. The calendar data entry may represent items such as meetings, meeting requests, appointments, due dates, and the like however represented by a calendaring system within a particular calendar. At step 105 a request associated with a calendar data entry may be received. The request may be associated with a new calendar data entry or an existing calendar data entry. The request may be received by a user device (e.g., a smart phone, a laptop, a personal computer, etc.) and/or by a server from the user device.

At step 110 one or more fields (e.g., calendar information) associated with a type of the new calendar data entry may be retrieved from a first software platform. The first software platform may comprise a customer relationship management (CRM) software platform. The first software platform may be any calendaring system including calendar applications such as Microsoft Outlook or any of a variety of other calendar applications, as well as calendars associated with other application programs that use time-oriented data such as financial programs (e.g., QuickBooks), scheduling and project management programs, and so forth. A calendar application may also include a calendar application on the user device. The first software platform may comprise a web-based calendaring system such as Google calendar or iCalendar or an enterprise application that uses time-oriented data such as SalesForce. A calendar supported by such a system may include a variety of calendar information.

The retrieval of the one or more fields may be based on a first software platform interface. The first software platform interface may comprise a software development kit (SDK). The first software platform interface may comprise an application programming interface (API). Access to the first software platform may include providing a username and password for authenticated access. Access may also include establishing a network connection to the first software platform where the first software platform is remote from the user device. In one embodiment, the first software platform interface may be a web-based service that receives user information including a location of the calendar (e.g., network location, path, username, password, etc.), and establishes access using the user-provided information.

The retrieval of the one or more fields may also be based on a type of the new calendar data entry. The type of calendar data entry may be associated with a purpose of a meeting associated with the calendar data entry. For example, a type of meeting may be a presentation meeting wherein only one user will be speaking and/or sharing information, a type of meeting may be a collaborative meeting wherein a plurality of users each need to be able to speak and/or share information. Other types of meetings are contemplated.

The retrieval of the one or more fields may also be filtered in any number of ways supported by calendar metadata, e.g., by location, by participant, or by any other data within the calendar system and/or calendar data entries. A calendar may have metadata applicable to the entire calendar such as an owner, file location information, access right information, and so forth. A calendar data entry may be associated with specific calendar information (e.g., one or more fields). For example, the one or more fields may include temporal information such as a time, a time period, a date, or a date range that specifies the time for a particular calendar data entry. The one or more fields may include metadata such as a location, a description, a meeting subject, participants (e.g., attendee identifiers such as name, e-mail address, phone number, and the like), and so forth. Each item of metadata may have associated text, numbers, dates, or the like. The one or more fields may also specify recurrence such as for birthdays, anniversaries, and the like. The one or more fields may also include attachments such as documents, media (e.g., audio, video, pictures, etc.), and the like, as well as hyperlinks to relevant information. The one or more fields may include reminder data specifying when and/or how to provide reminders concerned scheduled events. Still more generally, the one or more fields may include any information or links to information that might be relevant to a calendar data entry in a calendar.

At step 115 a user interface may be generated on the user device. The generation of the user interface may be based on the one or more fields. The user interface may display a list of existing calendar data entries. The user interface may comprise one or more interface elements configured to receive input from a user. The one or more interface elements may vary based on the one or more fields. For example, a meeting date field may be represented in the user interface as a calendar from which a user may select one or more dates. A meeting subject field may be represented in the user interface as a text box in which the user may type letters and/or numbers to indicate the subject of the meeting. Other interface elements are contemplated. At step 120 one or more values associated with the one or more fields may be received, via the user interface. For example, the one or more values may be input into the user device by a user. The one or more values may represent specific information associated with the new calendar data entry. For example, the selection of a specific date by the user according to a calendar interface element will establish the specific data as a value associated with the meeting date field.

At step 125 a communication address may be requested from a second software platform. The second software platform may comprise a videoconference software platform. The videoconference software platform may have an associated client program that may be resident on a plurality of computing devices and/or may have an associated web-based client accessible by the plurality of computing devices. The videoconference software platform may cause the plurality of computing devices to communicate an audio and/or video data stream to each of the other computing devices wherein each computing device receives an audio and/or video data stream from each other computing device. The communication address may comprise a uniform resource locator (URL). The communication address may be configured to facilitate establishment of a communication session among a plurality of computing devices. The communication session may comprise one or more of an audio communication session or an audio/video communication session. The type of calendar data entry and/or the one or more values may affect which communication address is generated by the second software platform. For example, a communication address may be generated by the second software platform to support a defined number of meeting attendees. The communication address may also indicate a meeting type. For example, the meeting may be a standard meeting with a limited number of participants that are each equally able to communicate utilizing the same technical capabilities. Alternatively, the meeting may also be a largely attended meeting, such as a webinar, where only a limited number of participants of a plurality of participants may communicate utilizing the same technical capabilities whereas the technical capabilities the remaining participants may have access to are limited, and not as robust. For example, the limited number of participants may choose to turn their cameras on and use their microphones to speak in the webinar whereas the remaining participants may be able to turn their camera on but may be unable to utilize their microphone to speak in the webinar.

The request for the communication address may be based on a second software platform interface. The second software platform interface may comprise an SDK and/or an API. Access to the second software platform may include providing a username and password for authenticated access. Access may also include establishing a network connection to the second software platform where the second software platform is remote from the user device. In one embodiment, the second software platform interface may be a web-based service that receives user information including a location of the calendar (e.g., network location, path, username, password, etc.), and establishes access using the user-provided information.

At step 130 the communication address may be received from the second software platform. The receipt of the communication address may be based on the second software platform interface.

At step 135 the one or more values associated with the one or more fields and the communication address may be sent to the first software platform based on the first software platform interface. The communication address may be attached to the one or more values associated with the one or more fields, as well as a request to create the new calendar data entry. The one or more values and the communication address may be provided to the first software platform as a singular package, which may reduce data size and increase the speed by which the package is sent to the first software platform.

The first software platform, upon receipt of the one or more values and the communication address, may be caused to create the new calendar data entry. The new calendar data entry may be based on the one or more values associated with the one or more fields and the communication address. The method 100 may also create the new calendar data entry in a calendar software program on the user device based on the one or more values associated with the one or more fields and the communication address.

The example method 100 described in FIG. 1 may also send a message to the second software platform 220, based on the creation of the new calendar data entry. The message may cause the second software platform 220 to create a calendar data entry associated with the new calendar data entry. For example the calendar data entry may allow for a calendar event to be created on the second software platform 220 that may correspond to the new calendar data entry created on the user device.

The example method 100 described in FIG. 1 may also validate the one or more values. For example, the one or more fields may require a specific input or value. In the case wherein the specified input is not provided, the one or more values may be found to be invalid. For example, a specific format of a date of the calendar data entry may be required to be input into the one or more fields, so that in the case wherein the provided date does not conform to the specified format, the input value of the one or more values may be found to be invalid. For example, the one or more values may require an amount of input data that satisfies a threshold, such as age of the user, or the amount of digits in a provided phone number, so that if any input data does not satisfy the threshold, the input value of the one or more values may be found to be invalid.

The example method 100 may also retrieve a plurality of existing calendar data entries from the first software platform based on the first software platform interface. The plurality of existing calendar data entries may be presented, via the user interface, to the user. This may include retrieving some or all calendar data entries from a calendar. The retrieval may also be parameterized so that only calendar data entries within a specified date/time range are retrieved. The retrieval may also be filtered in any number of ways supported by calendar metadata, e.g., by location, by participant, or by any other data within the calendar system and/or calendar data entries. A calendar may have metadata applicable to the entire calendar such as an owner, file location information, access right information, and so forth. Each calendar data entry may also include calendar information (e.g., one or more fields). For example, the calendar information may include temporal information such as a time, a time period, a date, or a date range that specifies the time for a particular calendar data entry. The calendar information may include metadata such as a location, a description, a meeting subject, participants (e.g., attendee identifiers such as name, e-mail address, phone number, and the like). The calendar information may also specify recurrence such as for birthdays, anniversaries, and the like. The calendar information may also include attachments such as documents, media (e.g., audio, video, pictures, etc.), and the like, as well as hyperlinks to relevant information. The calendar information may include reminder data specifying when and/or how to provide reminders concerned scheduled events. Still more generally, calendar information may include any information or links to information that might be relevant to a calendar data entry in a calendar. Furthermore, the plurality of existing data entries may be updated based on any additional information the user may provide to the first software platform. The plurality of existing data entries may also be updated based on any change to the existing calendar data entries that the user may make.

The example method 100 described in FIG. 1 may also send notifications and/or messages to a member of a select group, or a number of members of the group. For example, the members of the group may be associated with the user who initiated the original request. The members of the group may be provided an update on any request made by any member of the group on a regularly timed basis, such as daily or weekly. It is also understood that the members of the group may be provided an update on any request made by any member of the group by specific request as well. For example, the message may be one or more of an instant message, a cumulative email of all calendar data entries created in a single day by a member of the group, or a cumulative email of all calendar data entries created within a week by a member of the group. It is further understood that a member of the group may choose to include a user who may not be a member of the group in the message.

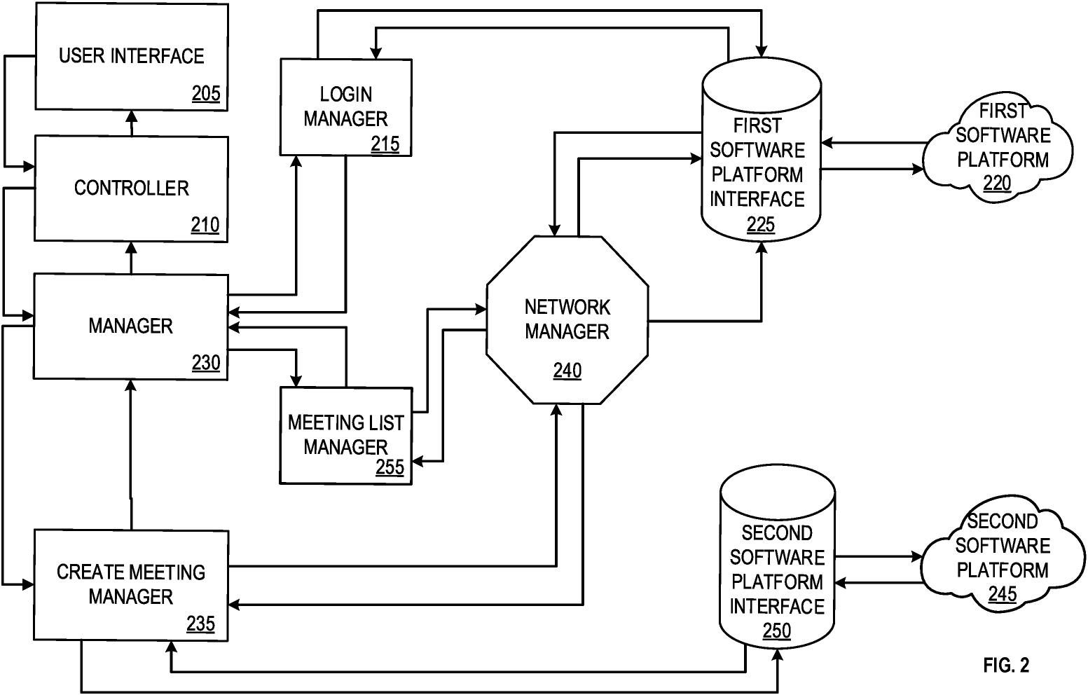

FIG. 2 illustrates an end-to-end flow of requests executed within an embodiment of the disclosure. Particularly, when a login request is received by the user device (not shown), via a user interface (UI) 205 of the user device, the login request may be sent to a controller 210. The login request may comprise a user credential, which may be a username and/or password unique to a user. However, it is understood that the login credential may be any form of authenticating data associated with the user. The controller 210 may determine an appropriate manager that will process the login request. For example, the controller 210 may send the login request to a login manager 215. The login manager 215 may communicate with a first software platform 220, via a first software platform interface 225, so that the first software platform 220 may authenticate the user.

In the instance wherein the user is successfully authenticated, the first software platform interface 225 may send a call back message to the login manager 215. The login manager 215 may send another call back message indicating success of the login request to the controller 210. The controller 210 may then indicate to the UI 205 that the user has been authenticated.

A request associated with a new calendar data entry may be received by the user device. The request associated with the new calendar data entry may be sent from the user device. The user may interact with the UI 205 in order to send the request associated with the new calendar data entry. The user may indicate a type of the new calendar data entry, via the UI 205. The controller 210 may determine an appropriate manager that will process the request associated with the new calendar data entry. For example, the controller 210 may send the request associated with the new calendar data entry to a manager 230. The manager 230 may forward the request associated with the new calendar data entry to a create meeting manager 235, which communicates with a network manager 240. The network manager 240 may process the request associated with the new calendar data entry and send, based on the network manager 240 communicating with the first software platform 220, via the first software platform interface 225, the request associated with the new calendar data entry to the first software platform 220.

The first software platform 220 may comprise a customer relationship management (CRM) software platform. The first software platform 220 may comprise a calendaring system including calendar applications such as Microsoft Outlook or any of a variety of other calendar applications, as well as calendars associated with other application programs that use time-oriented data such as financial programs (e.g., QuickBooks), scheduling and project management programs, and so forth. A calendar application may also include a calendar application on the user device. The first software platform may comprise a web-based calendaring system such as Google calendar or iCalendar or an enterprise application that uses time-oriented data such as SalesForce. A calendar supported by such a system may include a variety of calendar information.

The first software platform 220 may comprise a software or firmware process that manages one or more calendars associated with a user. The software or firmware includes programming code or instructions stored in a computer readable storage medium and executable by a processor. In one embodiment, the one or more calendars may be from distinct calendar platforms. For example, a user may have calendars hosted by distinct online calendar platforms (or services, systems) (e.g., GOOGLE CALENDAR, YAHOO! CALENDAR, etc.). The user may also have calendars provided by proprietary calendar platforms (e.g., MICROSOFT EXCHANGE SERVER, SALESFORCE). The network manager 240 is configured to retrieve one or more fields necessary for creation of a new calendar data entry from these associated calendars. The one or more fields may be one or more of: a meeting subject, a meeting date, a meeting time, a meeting location, a meeting title, or one or more meeting attendee identifiers.

The retrieval of the one or more fields may also be based on a type of the new calendar data entry. The type of calendar data entry may be associated with a purpose of a meeting associated with the calendar data entry. For example, a type of meeting may be a presentation meeting wherein only one user will be speaking and/or sharing information, a type of meeting may be a collaborative meeting wherein a plurality of users each need to be able to speak and/or share information. Other types of meetings are contemplated.

The retrieval of the one or more fields may also be filtered in any number of ways supported by calendar metadata, e.g., by location, by participant, or by any other data within the calendar system and/or calendar data entries. A calendar may have metadata applicable to the entire calendar such as an owner, file location information, access right information, and so forth. A calendar data entry may be associated with specific calendar information (e.g., the one or more fields). For example, the one or more fields may include temporal information such as a time, a time period, a date, or a date range that specifies the time for a particular calendar data entry. The one or more fields may include metadata such as a location, a description, a meeting subject, participants (e.g., attendee identifiers such as name, e-mail address, phone number, and the like), and so forth. Each item of metadata may have associated text, numbers, dates, or the like. The one or more fields may also specify recurrence such as for birthdays, anniversaries, and the like. The one or more fields may also include attachments such as documents, media (e.g., audio, video, pictures, etc.), and the like, as well as hyperlinks to relevant information. The one or more fields may include reminder data specifying when and/or how to provide reminders concerned scheduled events. Still more generally, the one or more fields may include any information or links to information that might be relevant to a calendar data entry in a calendar.

Once the network manager 240 retrieves the one or more fields, the one or more fields may be provided to the create meeting manager 235 and through the manager 230 and the controller 210, cause a UI 205 to be generated on the user device to receive one or more values for the one or more fields. The UI 205 may comprise one or more interface elements configured to receive input from a user. The one or more interface elements may vary based on the one or more fields. For example, a meeting date field may be represented in the user interface as a calendar from which a user may select one or more dates. A meeting subject field may be represented in the user interface as a text box in which the user may type letters and/or numbers to indicate the subject of the meeting. Other interface elements are contemplated. The user may interact with the UI 205 by inputting one or more values that are associated with the one or more fields displayed by the UI 205. For example, the one or more fields may present fillable fields to the user, wherein the user may input a date of the calendar data entry or a subject of the calendar data entry. It is understood that the one or more fields may differ based on the type of the request. It is also understood that the user may input any information for the one or more fields based on the type of the calendar data entry.

The one or more values provided by the user may be validated to determine whether the one or more values satisfy minimum specifications required by the one or more fields and predefined parameters installed within the software application. For example, the one or more fields may require a specific input or value. In the case wherein the specified input is not provided, the one or more values may be found to be invalid. For example, a specific format of a date of the calendar data entry may be required to be input into the one or more fields, so that in the case wherein the provided date does not conform to the specified format, the input value of the one or more values may be found to be invalid. For example, the one or more values may require an amount of input data that satisfies a threshold, such as age of the user, or the amount of digits in a provided phone number, so that if any input data does not satisfy the threshold, the input value of the one or more values may be found to be invalid.

As described herein, the manager 230 may forward the request associated with the new calendar data entry to the create meeting manager 235, which communicates with the network manager 240 to cause the network manager 240 to retrieve the one or more fields from the first software platform 220. The create meeting manager 235 may also send a request for a communication address to a second software platform 245 via a second software platform interface 250. The create meeting manager 235 may send the request for a communication address based on the initial receipt of the request associated with the new calendar data entry, based on receipt of the one or more fields, based on a validation of input values associated with the one or more fields through the UI 205, based on a user request conveyed through the UI 205, and the like. The create meeting manager 235 may send the request for a communication address to the second software platform in parallel with the network manager 235 sending the request associated with the new calendar data entry to the first software platform.

The second software platform 245 may comprise a communication software platform. The second software platform 245 may comprise an audio and/or video conferencing software platform including communication software applications such as ZOOM, SKYPE, MICROSOFT TEAMS, GOOGLE HANGOUTS MEET, CISCO WEBEX, and the like. The second software platform 245 may comprise a software or firmware process that manages one or more communication sessions. The software or firmware includes programming code or instructions stored in a computer readable storage medium and executable by a processor.

The create meeting manager 235 is configured to send the request for the communication address to the second software platform 245. The communication address may comprise a uniform resource locator (URL). The communication address may be configured to facilitate establishment of a communication session among a plurality of computing devices. The communication session may comprise one or more of an audio communication session or an audio/video communication session. The type of calendar data entry and/or the one or more values may affect which communication address is generated by the second software platform. For example, a communication address may be generated by the second software platform to support a defined number of meeting attendees.

The communication address may be configured such that, upon selecting (e.g., clicking) on the communication address, an audio and/or video communication session may be initiated. For example, when the communication address is selected, a telephone number may dialed to join a telephone conference or a user device may be connected to an online meeting using instant messaging, an online presentation, a multimedia presentation, a video conference, an online chat, and the like.

The create meeting manager 235 may receive the communication address from the second software platform 245 and associated the communication address with the one or more values associated with the one or more fields. The create meeting manager 235 may send the communication address and the one or more values associated with the one or more fields to the network manager 240. The network manager 240 may send the communication address and the one or more values associated with the one or more fields, along with an instruction/request to create the new calendar data entry, to the first software platform 220 via the first software platform interface 225.

The first software platform 220 may be caused to create the new calendar data entry. The created calendar data entry may be added to a list of existing calendar data entries.

In an embodiment, a request for an existing calendar data entry(ies) may be processed by a meeting list manager 255, via the manager 230. The request for the existing calendar data entry(ies) may be sent to the network manager 240. The network manager 240 may communicate with the first software platform 220, via the first software platform interface 225 so that the existing calendar data entry(ies) may be provided to the user device. In the instance wherein existing calendar data entry(ies) are received by the network manager 240, the network manager 240 may then provide a call back to the manager 230, via the meeting list manager 255 indicating receipt of the existing calendar data entry. The first software platform 220 may provide a plurality of existing calendar data entries to the user device. The meeting list manager 255 may forward a request from the manager 230 to retrieve all the existing calendar data entries from the first software platform 220. When the request is processed, a call back is provided back to the controller 210, which includes an update to provide a list of the existing calendar data entries upon the UI 205 of the user device.

In another embodiment, each of the aforementioned components that are discussed in the description of FIG. 2 may be organized to operate within a cloud-based environment that may be able to process the method described in FIG. 1. However, it is understood that the components embodied within FIG. 2 may be organized to operate within any environment, not limited to only a cloud-based environment. It is also understood that the components embodied within FIG. 2 may be able to process any method, not limited only to the method described in FIG. 1.

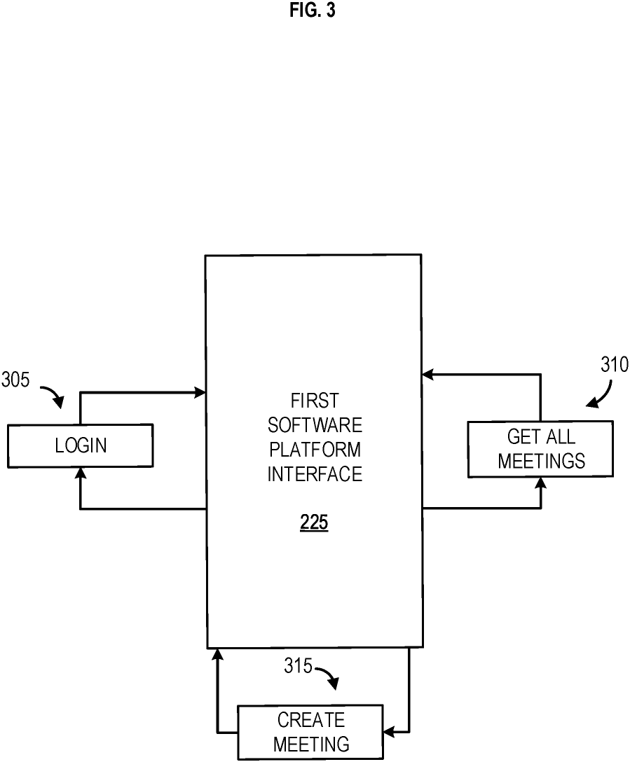

FIG. 3 illustrates the first software platform interface 225. The user provides login credentials, through the UI 205, so that the user may be authenticated with the first software platform 220, via the first software platform interface 225, through a login process 305. For example, the UI 205 may provide a login screen to the user on the user device. The user may input the login credential on the login screen. For example the login credential may comprise a username and password. However, it is understood that the login credentials may be any type of information, including identifying information unique to a specific user. In an aspect, the login process 305 may require, from the user, a selection of a particular server. For example, the server may be any instance of the first software platform 220, although it is understood that an indication of the server may not be required at all, and that the server may be associated with any software platform. The login process 305 forwards the login credentials to the first software platform 220, via the first software platform interface 225 so that the first software platform 220 may authenticate the user, based on the provided login credentials. In the event wherein the user device is authenticated, the first software platform interface 230 sends an indication to the user that the login request is successful.

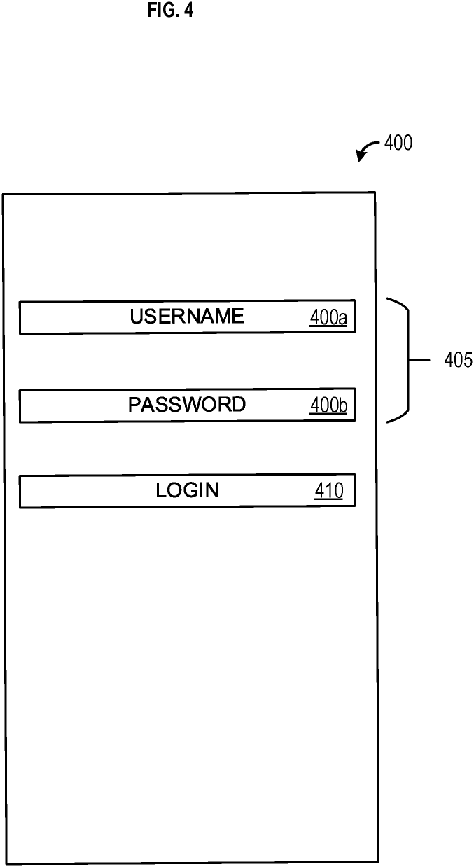

FIG. 4 illustrates the UI 205 by which the login credential may be provided, by the user, via a login screen 400. The user may provide login credentials 405 to the first software platform 220, via the first software platform interface 225, through the login process 305. Particularly, the user may input a username 400a and a password 400b into the login screen 400. Once the username 400a and the password 400b is input, the user may select a login button 410. The login button 410 may indicate a particular server the user intends to utilize. However, it is understood that no particular server is required to be indicated by the user at all.

Returning to FIG. 3, the UI 205 may update, based on the authentication of the user, so that the login screen 400 is replaced with a list of existing calendar data entries via a get all meetings process 310. It is understood that there may, or may not be, an existing list of calendar data entries that may replace the login screen 400. Nevertheless, a network request, from the first software platform interface 225, may be generated to fetch any existing calendar data entries from the first software platform 220.

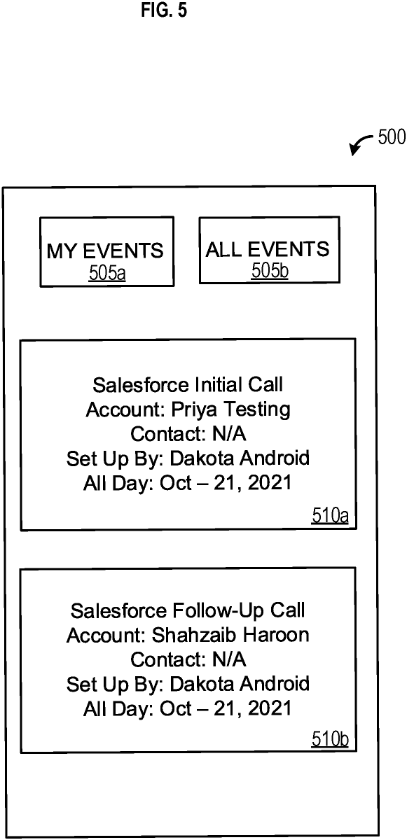

FIG. 5 illustrates an existing calendar data entry list screen 500 on the UI 205, upon which a list of existing calendar data entries may be displayed on the user device. A filter option may be provided on the existing calendar data entry list screen 500 that allows a user to filter the existing calendar data entries based on “My Events” 505a or “All Events” 505b. However, it is understood that any filter may be utilized to organize the list of existing calendar data entries 510a, 510b. It is also understood that a filter is not required to be included on the existing calendar data entry list screen 500 at all.

Returning to FIG. 3, a create meeting process 315 may be configured to cause the retrieval of one or more fields associated with a new calendar data entry, in some instances based on a type of new calendar data entry. The UI 205 may present one or more interface elements associated with the one or more fields associated with a type of the new calendar data entry. The user may input the one or more values into the one or more fields. The create meeting process 315 may also be configured to send values for the one or more fields along with a communication address retrieved from the second software platform 245 to the first software platform 250. The create meeting process 315 may cause the first software platform 250 to create the new calendar data entry in a calendar of the first software platform 250. In the instance wherein the new calendar data entry is created, the new calendar data entry may be added to the list of existing calendar data entries.

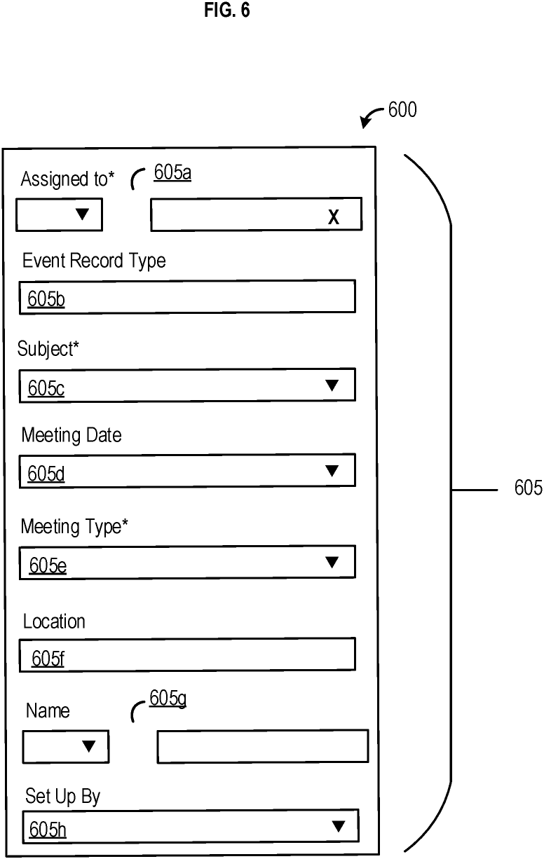

FIG. 6, illustrates a prompt screen 600, upon which the one or more values may be input into one or more interface elements associated with the one or more fields 605 associated with a type of a new calendar data entry by the user, via the UI 205. Particularly, the UI 205 may display the one or more fields 605 so that the user may input the one or more values. For example, the UI 205 may provide one or more interface elements that correspond to the one or more fields 605 related to which user the new calendar data entry is assigned to 605a, the event record type of the new calendar data entry 605b, the subject of the new calendar data entry 605c, the date of the new calendar data entry 605d, the type of the new calendar data entry 605e, the location of the new calendar data entry 605f, a name of an attendee related to the new calendar data entry 605g, and which user is organizing the meeting represented by the new calendar data entry 605h. However, it is understood that a value may not be required for every field in order for a new calendar data entry to be scheduled. For example, the user device may be required to input the subject of the new calendar data entry 305c and the type of the new calendar data entry 305e, but not the location of the new calendar data entry 305f. It is also understood that the user device may input the one or more values in each of the one or more fields 605 so that the new calendar data entry may be created. The create meeting command may be initiated once required values are entered and/or validated.

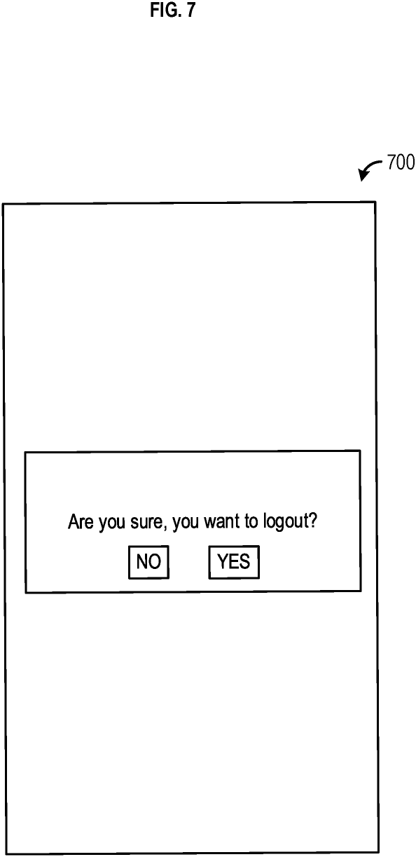

FIG. 7 illustrates a logout screen 700 on the UI 205, wherein the user is prompted to confirm the user’s intention to logout of the application. However, it is understood that the UI 205 may not present the user with a logout screen 700 that prompts the user to confirm the user’s intention to logout of the application. Rather, it is understood that the application may simply logout the user from the application without a logout screen 700 at all.

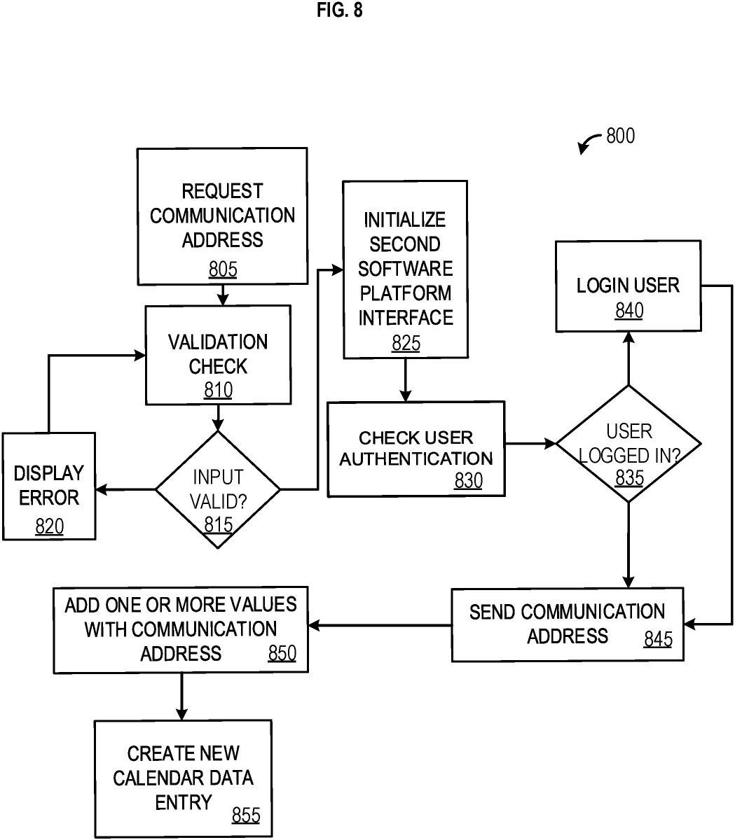

FIG. 8 is a flowchart illustrating another example method 800 for the management of calendar data. At 805, by inputting the one or more values into the one or more fields based on the type of calendar data entry, the user may send, or cause the sending of, a create meeting command for a communication address. At 810, based on the input of the one or more values into the one or more fields 605 associated with the type of the new calendar data entry that is provided by the user, the values may be validated. For example, if the user fails to input a required value associated with the one or more fields 605, the input will not be valid at 815 and an error will be displayed at 820. If the values input are valid at 815, the second software platform interface 225 may be initialized at 825. The second software platform interface 225 may authenticate the user credentials at 830. For example, the user may be required to input a user credential that may comprise a username and password unique to the user operating the user device. However, it is understood that the user credential may be any type of authenticating credential. In the case wherein the user credentials are valid, the second software platform 220 may then determine whether the user device is logged in at 835. In the case wherein the user device is not logged in, the second software platform 220, via the second software platform interface 225, may login the user device at 840. Upon successful login, or confirmation of login, the second software platform 245 may then generate and send the communication address at 845 to the create meeting manager 235.

At 850, once the communication address is sent to the create meeting manager 235, the create meeting manager 235 may combine, package, aggregate, etc., the one or more values associated with the one or more fields 605 and the communication address. The one or more values associated with the one or more fields 605 and the communication address may be sent to the first software platform 220, via the first software platform interface 225. At 855, the first software platform 220, based on the one or more values associated with the one or more fields 605 and the communication address, may create the new calendar data entry. The new calendar data entry may be added to the existing list of calendar data entries and may be provided to the user via the UI 205.

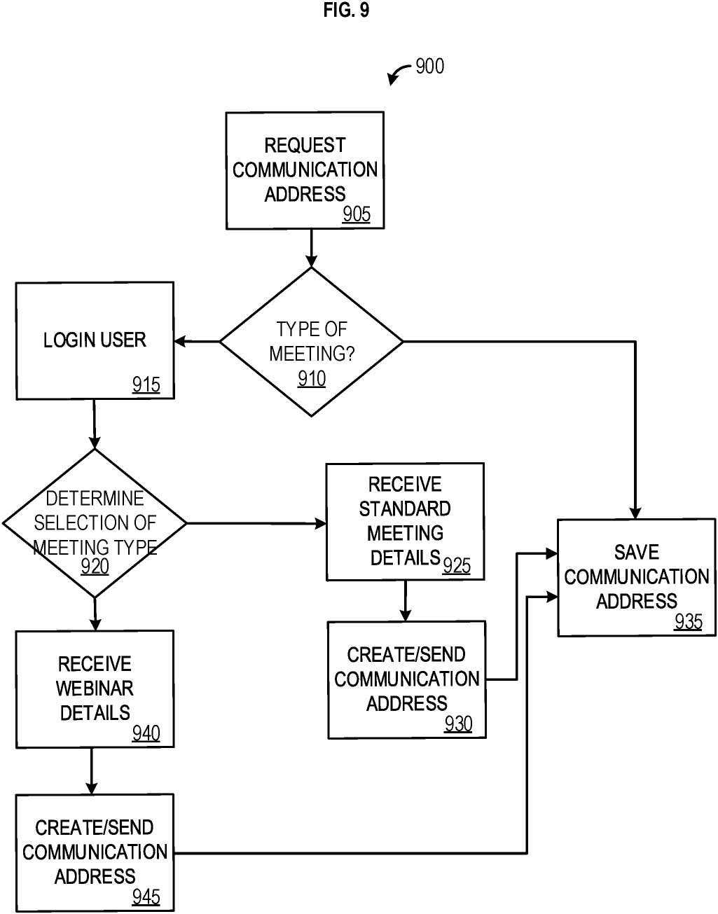

FIG. 9 is a flowchart illustrating another example method 900 for the management of calendar data. More specifically, the method 900 may allow for a user to request a specific type of meeting to be created, based on calendar data. At 905, by inputting the one or more values into the one or more fields 605 based on the type of calendar data entry, the user may send, or cause the sending of, a create meeting command for a communication address. The create meeting command for the communication address may be sent to the second software platform 245. At 910, based on the input of the one or more values into the one or more fields 605 associated with the type of new calendar data entry that is provided by the user, the user may indicate the selection of a specific type of meeting. For example, the meeting may be a standard meeting with a limited number of participants that are each equally able to communicate utilizing the same technical capabilities. Alternatively, the meeting may also be a largely attended meeting, such as a webinar, where only a limited number of participants of a plurality of participants may communicate utilizing the same technical capabilities whereas the technical capabilities the remaining participants may have access to are limited, and not as robust. For example, the limited number of participants may choose to turn their cameras on and use their microphones to speak in the webinar whereas the remaining participants may be able to turn their camera on but may be unable to utilize their microphone to speak in the webinar. At 915, the user may engage with the second software platform interface 250 in order to log in to the second software platform 245. It is understood, however, that the user may already be logged into the second software platform 245. At 920, the second software platform 245 may determine what type of meeting has been selected. For example, the user may have selected either a standard meeting or a webinar, although it is understood that any variation of a meeting may be indicated by the user. In the instance wherein the standard meeting is selected by the user, the second software platform 245, via the second software platform interface 250, may receive details related to the standard meeting at 925. At 930, the second software platform 245 may generate a communication address, inclusive of the selected meeting and related details, that may be sent to the first software platform 220. At 935, the first software platform 220 may save the communication address. In the instance wherein the webinar is selected by the user, the second software platform 245, via the second software platform interface 250, may receive details related to the webinar at 940. At 945, the second software platform 245 may generate a communication address, inclusive of the selected meeting and related details, that may be sent to the first software platform 220. At 935, the first software platform 220 may save the communication address. It is understood that a set of types of meetings may be stored within the second software platform 245. For example the second software platform 245 may only include the meeting or the webinar as options for a type of meeting the user may select. However, it is understood that the second service platform 245 may include any number and any type of meeting(s) as an option for a type of meeting the user may select. In the case wherein no viable selection is made by the user relative to the set of types of meetings stored within the second service platform 245, the second service platform 245 may indicate to the first service platform 220 that no preference for a type of meeting was made, and the first service platform 220 may then choose any type of meeting by default. However, it is also understood that if the user makes no viable selection relative to the set of types of meetings stored within the second service platform 245, the second service platform 245 may indicate to the first service platform 220 that no selection was made and the method 100 described in FIG. 1 may be interrupted until a user selection is made indicating a specific meeting type.

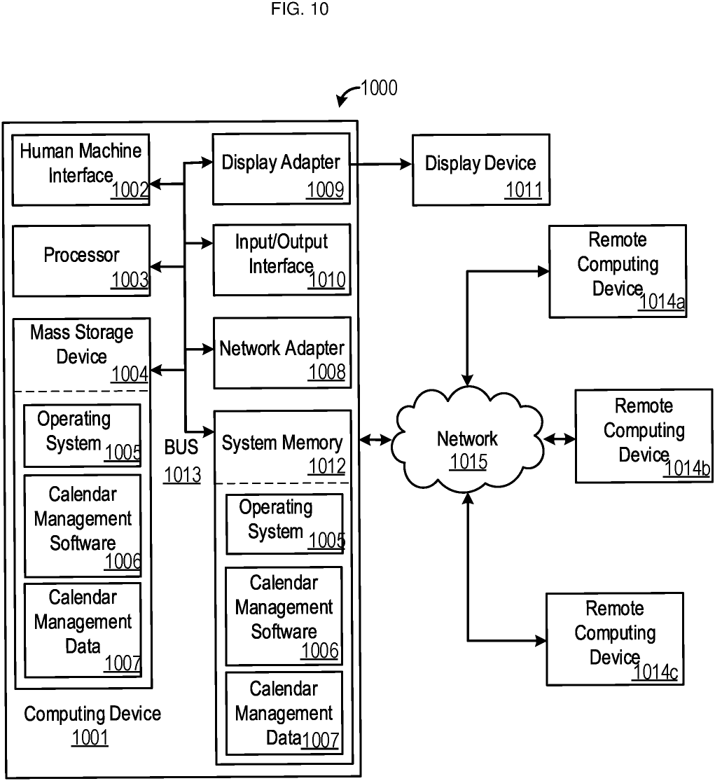

FIG. 10 shows an example system 1000 for scheduling a meeting. Although only certain devices and/or components are shown, the system 1000 may comprise a variety of other devices and/or components that support a wide variety of functions, such as network and/or communication functions. Those skilled in the art will appreciate that the present systems and methods may be used in various types of networks and systems that employ both digital and analog equipment.

The system 1000 may include a computing device 1001. The computing device 1001 may comprise one or more processors or processing units 1003, a system memory 1012, and a system bus 1013 that couples various system components of the computing device 1001, including the processor 1003, to the system memory 1012. In the case of multiple processing units 1003, the system may utilize parallel computing.

The system bus 1013 represents one or more of several possible types of bus structures, including a memory bus or memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnects (PCI), a PCI-Express bus, a Personal Computer Memory Card Industry Association (PCMCIA), Universal Serial Bus (USB), and the like.

The bus 1013 may also be implemented over a wired or wireless network connection to each of the subsystems, including the processor 1003, a mass storage device 1004, an operating system 1005, calendar management software 1006, calendar management data 1007, a network adapter 1008, an Input/Output (I/O) interface 1010, a display adapter 1009, a display device 1011, and a human machine interface 1002. It is understood that the bus 1013 and each of the aforementioned subsystems may be contained within one or more remote computing devices 1014a, 1014b, 1014c at physically separate locations, connected through buses of this form, in effect implementing a fully distributed system.

The computing device 1001 may operate on and/or comprise a variety of computer-readable media (e.g., non-transitory computer-readable media). Computer-readable media may be any available media that is accessible by the computing device 1001 and comprises both volatile and non-volatile media and removable and non-removable media. The system memory 1012 comprises computer-readable media in the form of volatile memory, such as random access memory (RAM), and/or non-volatile memory, such as read only memory (ROM). The system memory 1012 typically contains data and/or program modules, such as an operating system 1005, calendar management software 1006, and calendar management data 1007, that are accessible to and/or are operated on by the one or more processors 1003.

The computing device 1001 may also comprise other removable/non-removable, volatile/non-volatile computer storage media. By way of example, the mass storage device 1004 may provide non-volatile storage of computer code, computer readable instructions, data structures, program modules, and other data for the computing device 1001. For example, the mass storage device 1004 may be a hard disk, a removable magnetic disk, a removable optical disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

A display device 1011 may also be connected to the system bus 1013 via an interface, such as the display adapter 1009. It is contemplated that the computing device 1001 may have more than one display adapter 1009 and the computing device 1001 may have more than one display device 1011. For example, a display device may be a monitor, an LCD (Liquid Crystal Display), light emitting diode (LED) display, smart glass, or a projector. In addition to the display device 1011, other output peripheral devices may comprise components, such as speakers (not shown) and a printer (not shown) which may be connected to the computing device 1001 via the Input/Output Interface 1010. Any step and/or result of the methods may be output in any form to an output device. Such output may be any form of visual representation, including, but not limited to, textual, graphical, animation, audio, tactile, and the like. The display device 1011 and the computing device 1001 may be part of one device, or separate devices.

Logical connections between the computing device 1001 and any of the remote computing devices 1014a, 1014b, 1014c, may be made via a network 1015, such as a local area network (LAN) and/or a general wide area network (WAN). Such network connections may be through a network adapter 1008. The network adapter 1008 may be implemented in both wired and wireless environments. Such networking environments are conventional and commonplace in dwellings, offices, enterprise-wide computer networks, intranets, and the Internet.

For purposes of illustration, application programs and other executable program components, such as the operating system 1005 are illustrated herein as discrete blocks, although it is recognized that such programs and components reside at various times in different storage components of the computing device 1001, and are executed by the data processor(s) of the computing device 1001. Any of the disclosed methods may be performed by computer-readable instructions embodied on computer-readable media.

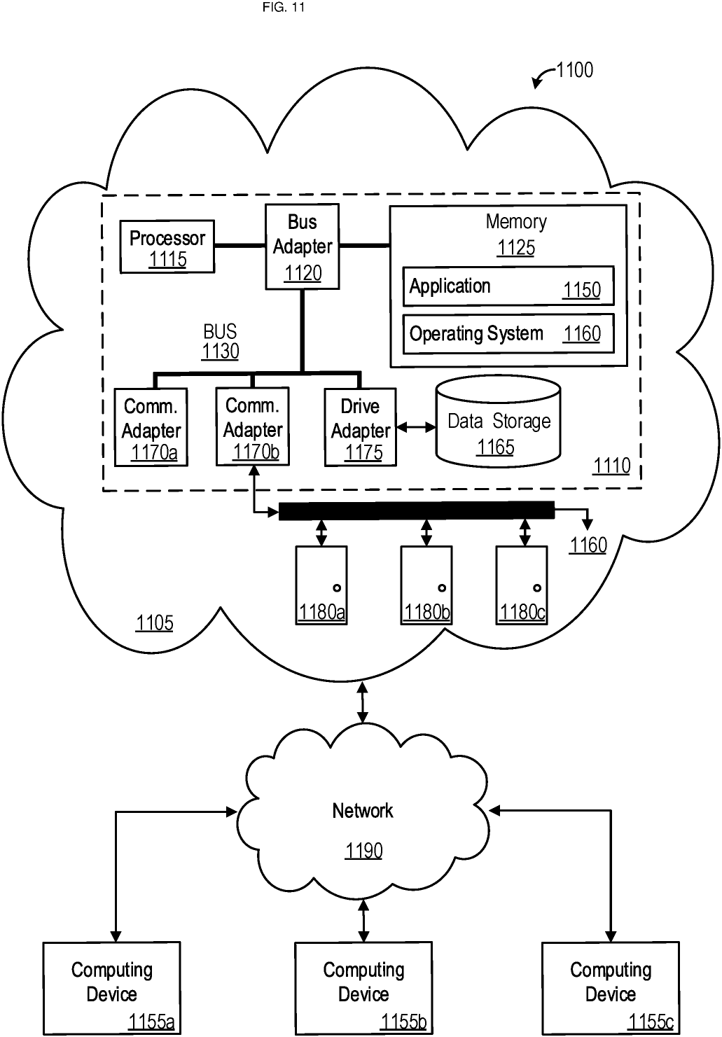

FIG. 11 shows an example system 1100 for data processing relative to adding index annuities to a fund within a cloud computing environment. While the cloud computing environment illustrates the use of only a single cloud 1105 it is understood that any number of clouds may be included in the cloud computing environment. The cloud 1105 may be a network-based, distributed data processing system that may provide one or more cloud computing services.

The cloud 1105 may include a server 1110 that may comprise one or more processors or processing units 1115, a bus adapter 1120, and a memory 1125, each of which may be connected through a high speed memory bus 1130. Stored in the memory 1125 may be an application 1150, which may be a module of computer program instructions for carrying out particular data processing tasks that may require cloud computing services for application delivery to computing devices 1155a-1155c or a user of the computing devices 1155a-1155c. The memory 1125 may also store an operating system 1160. Examples of the operating system 1160 may include, but is not limited to, UNIX, Linux, Microsoft XP, or AIX. It is understood that the memory 1125 may include other components. It is also understood that while random access memory (RAM) may be used, for example, any type of memory may be used, such as non-volatile memory that may be represented by a data storage 1165.

The server 1110 may also include one or more data communication adapters 1170a, 1170b and a drive adapter 1175, each of which are connected through the memory bus 1130. The drive adapter 1175 may connect non-volatile data storage to the server 1110 in the form of the data storage 1165. Drive adapters useful for data processing in a cloud computing environment may include Integrated Drive Electronics adapters, Small Computer System Interface adapters, and others as will occur to those of skill in the art. Non-volatile computer memory also may be implemented for use as an optical disk drive, electronically erasable programmable read-only memory, RAM drives, and so on, as will occur to those of skill in the art. Data communication networks may be carried out through external buses such as a Universal Serial Bus, through other data communications data communication networks such as IP data communication networks, and in other ways as will occur to those of skill in the art. Communication adapters implement the hardware level of data communications through which one computer sends data communications to another computer, directly or through a data communications network. Examples of communication adapters may include modems for wired dial-up communications, Ethernet adapters for wired data communication network communications, and Ethernet adapters for wireless data communications network communications.

Also included in the server 1110 may be an internally disposed network 1160 that allows for servers 1180a-1180c to communicate with the communication adapter 1170b. Although the servers 1180a-1180c are illustrated as being disposed within the cloud 1105, it is understood that the cloud may communicate to servers located externally from the cloud 1105 as well. The cloud 1105 may also communicate with each of the computing devices 1155a-1155c via a network 1190, such as a local area network and/or a general wide area network. It is understood that, while not depicted, the network 1190 may include a server(s) that may facilitate the communication between the application 1150 of the cloud 1105 and each of the computing devices 1155a-1155c.

While the methods and systems have been described in connection with example embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a computing device, a request associated with a new calendar data entry;
retrieving, based on a first software platform interface and a type of the new calendar data entry, one or more fields associated with the type of the new calendar data entry from a first software platform;
generating, based on the one or more fields, a user interface on the user device;
receiving, via the user interface, one or more values associated with the one or more fields;
requesting, based on a second software platform interface, a communication address from a second software platform;
receiving, based on the second software platform interface, the communication address from the second software platform; and
sending, based on the first software platform interface, the one or more values associated with the one or more fields and the communication address to the first software platform to cause the first software platform to create the new calendar data entry based on the one or more values associated with the one or more fields and the communication address.

2. The method of claim 1, wherein the first software platform interface comprises a software development kit (SDK) or an application programming interface (API).

3. The method of claim 1, wherein the first software platform comprises a customer relationship management (CRM) software platform.

4. The method of claim 1, wherein the type of calendar data entry is associated with a purpose of a meeting associated with the calendar data entry.

5. The method of claim 1, wherein the one or more fields associated with the type of calendar data entry comprise one or more of: a meeting subject, a meeting date, a meeting time, a meeting location, a meeting title, or one or more meeting attendee identifiers.

6. The method of claim 1, wherein the second software platform interface comprises a software development kit (SDK) or an application programming interface (API).

7. The method of claim 1, wherein the second software platform comprises a communication session software platform.

8. The method of claim 1, wherein the communication address comprises a uniform resource locator (URL).

9. The method of claim 1, wherein the communication address is configured to facilitate establishment of a communication session among a plurality of computing devices.

10. The method of claim 9, wherein the communication session comprises one or more of: an audio communication session or an audio/video communication session.

11. The method of claim 1, further comprising authenticating, based on a user credential, the user device with the first software platform.

12. The method of claim 1, further comprising authenticating, based on a user credential, the user device with the second software platform.

13. The method of claim 1, further comprising validating the one or more values.

14. The method of claim 1, further comprising:
retrieving, based on the first software platform interface, a plurality of calendar data entries; and
presenting the plurality of calendar data entries via the user interface.

15. The method of claim 1, further comprising creating, based on the one or more values associated with the one or more fields and the communication address, the new calendar data entry in a calendar software program on the user device.

16. The method of claim 1, further comprising sending, based on the creation of the new calendar data entry, a message to the second software platform to cause the second software platform to create a calendar data entry associated with the new calendar data entry.

17. The method of claim 1, further comprising causing, based on the creation of the new calendar data entry, a message to be sent to the user device or a plurality of user devices, wherein the message indicates the creation of the new calendar data entry.

18. The method of claim 17, wherein the message comprises one or more of: an instant message, a cumulative email of all calendar data entries created in a day, or a cumulative email of all calendar data entries created within a week.

19. The method of claim 14, further comprising updating, based on the receipt of one or more new values associated with the one or more fields, the plurality of calendar data entries.

20. The method of claim 1, wherein the communication address indicates a meeting type.
